(19) United States
(12) Patent Application Publication
(10) Pub. No.: US 2025/0206019 A1
(43) Pub. Date: Jun. 26, 2025

(54) LIQUID EJECTION HEAD AND LIQUID EJECTION DEVICE

(71) Applicant: RISO Technologies Corporation, Tokyo (JP)

(72) Inventors: Hiroyuki WATANABE, Mishima Shizuoka (JP); Masashi SHIMOSATO, Mishima Shizuoka (JP)

(21) Appl. No.: 18/783,179

(22) Filed: Jul. 24, 2024

(30) Foreign Application Priority Data
Dec. 25, 2023 (JP) 2023-217885

(51) Int. Cl. B41J 2/14

(52) U.S. Cl. CPC B41J 2/1404; B41J 2/14209

(57) ABSTRACT

A liquid ejection head includes pressure chambers, each connected to a nozzle. A first-side common chamber is on one side of the pressure chambers and a second-side common chamber is on another side of the pressure chambers. Coupling flow channels connect the pressure chambers to the first-side common chamber and the second-side common liquid chamber. A cross-sectional area of each pressure chamber taken perpendicular to a first direction between the first- and second-side common chambers is less than or equal to 0.01 mm². A cross-sectional area of each coupling flow channel taken perpendicular to the first direction is less than one quarter of the cross-sectional area of each pressure chamber.

### CROSS-REFERENCE TO RELATED APPLICATION

This application is based upon and claims the benefit of priority from Japanese Patent Application No. 2023-217885, filed Dec. 25, 2023, the entire contents of which are incorporated herein by reference.

### FIELD

The present disclosure relates to a liquid ejection head and a liquid ejection device.

### BACKGROUND

In a liquid ejection head, such as an inkjet head, there can be a vibrating plate that is deformed by an actuator. The actuator may be formed of a piezoelectric material such as lead zirconate titanate (PZT). The vibrating plate deforms and causes a pressure chamber adjacent to the vibrating plate to eject ink from a nozzle connected to the pressure chamber. The liquid ejection head can have a plurality of actuators bonded to the vibrating plate. The liquid ejection head has therein flow channels through which liquid to be ejected flows to and through adjacent pressure chambers to the vibrating plate. The performance of such an inkjet head may be significantly affected by fluid flow resistance in the flow channels. Specifically, when the cross-sectional area of a flow channel is large, the meniscus vibration after ejection at the nozzle generally increases, and when the cross-sectional area is small, refilling (liquid inflow) slows. Both these issues may hinder high-speed performance of the inkjet head.

When the pressure chamber and the fluid flow channel (or a high resistance part thereof) are not sufficiently different in size from each other, a parasitic vibration occurs in the pressure chamber, and when this parasitic vibration becomes strong, an ejection failure occurs. In the case of a circulation type inkjet head, when the pressure chamber is too large, the flow rate through the pressure chamber decreases, and liquid circulation (recirculation) cannot be easily provided. However, when the size of the pressure chamber is reduced, the difference in size between the high resistance part of the flow channel and the pressure chamber decreases, and parasitic vibration is more likely to occur.

### BRIEF DESCRIPTION OF THE DRAWINGS

FIG. 1 is a cross-sectional view of a part of an inkjet head according to a first embodiment.

FIG. 2 is a cross-sectional view of a part of an inkjet head.

FIG. 3 is a plan view of a flow channel unit.

FIG. 4 is a graph related to flow channel shape and

vibration characteristics.

FIG. 5 depicts droplet ejection states with different drive conditions.

FIG. 6 is a table showing ejection characteristics under different conditions.

FIG. 7 depicts a schematic configuration of an inkjet recording device according to a first embodiment.

### DETAILED DESCRIPTION

According to one embodiment, a liquid ejection head includes plurality of pressure chambers. Each pressure chamber is connected to a nozzle. A first-side common liquid chamber is on a first side of the plurality of pressure chambers. A second-side common liquid chamber is on a second side of the plurality of pressure chambers. The plurality of pressure chambers is between the first-side common liquid chamber and the second-side common liquid chamber in a first direction. A plurality of first coupling flow channels is provided, each first coupling flow channel being respectively connected to a first side of one of the pressure chambers and the first-side common liquid chamber. A plurality of second coupling flow channels is also provided, each second coupling flow channel being respectively connected to a second side of one of the pressure chambers and the second-side common liquid chamber. A cross-sectional area of each pressure chamber in the plurality of pressure chambers taken perpendicular to the first direction is less than or equal to 0.01 mm². A cross-sectional area of each of the first and second coupling flow channels taken perpendicular to the first direction is less than one quarter of the cross-sectional area of each pressure chamber in the plurality of pressure chambers.

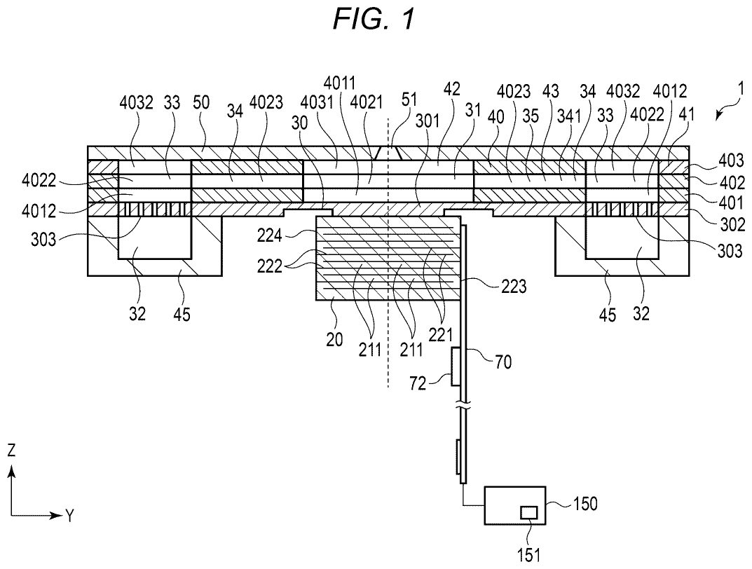

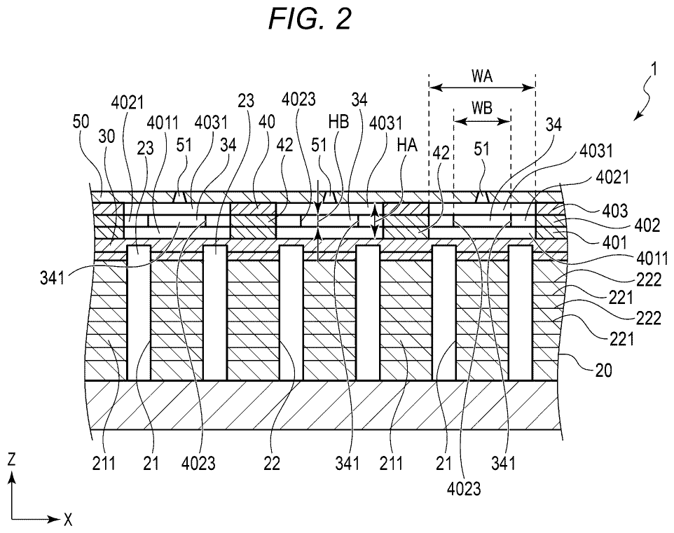

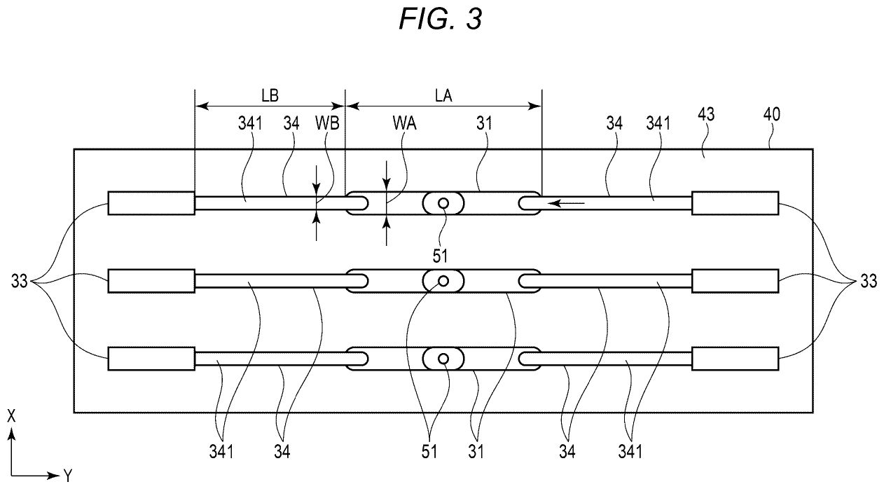

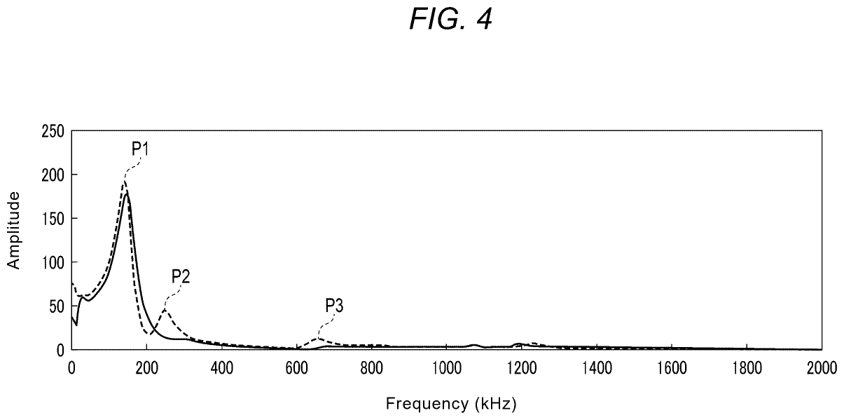

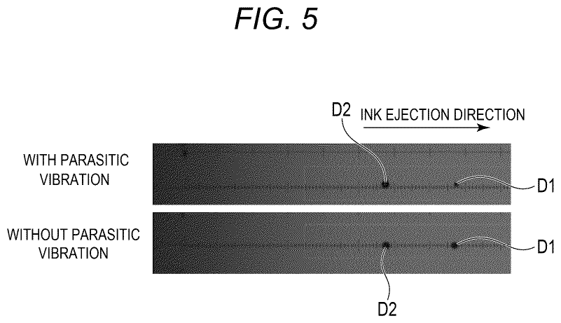

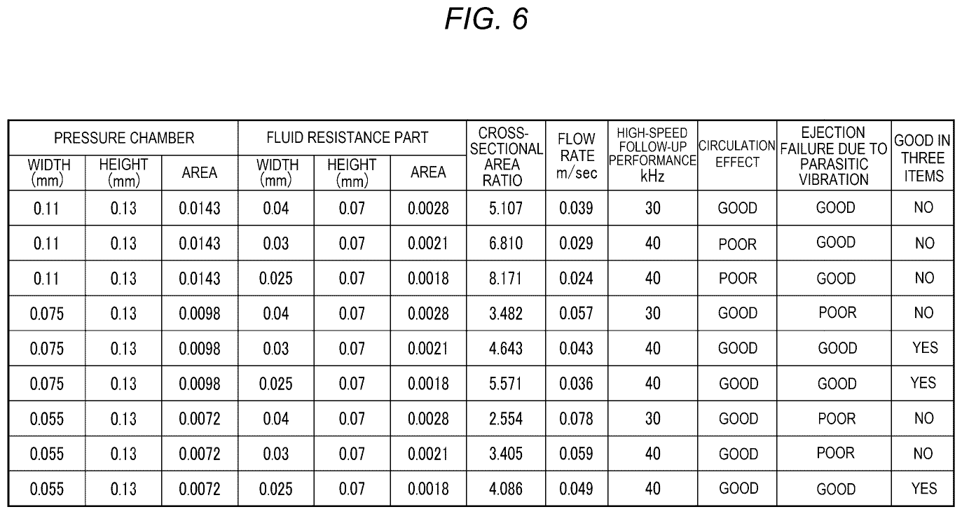

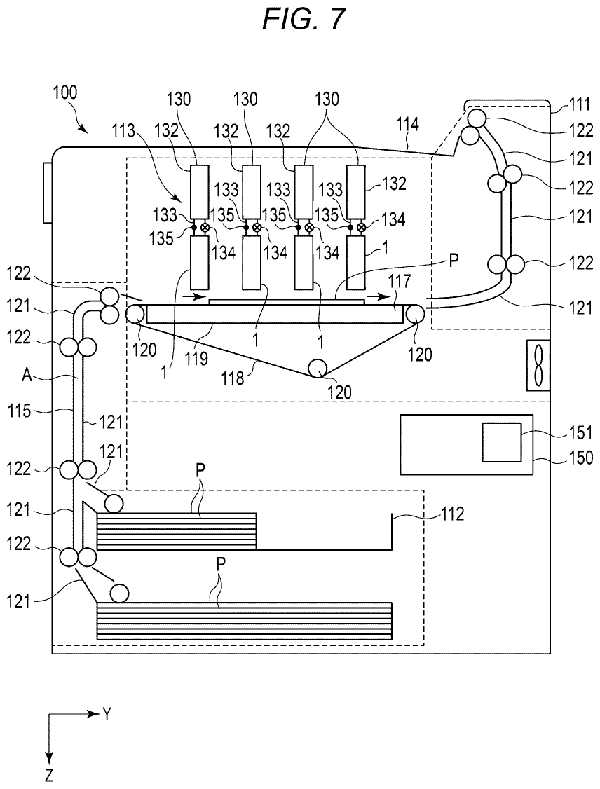

An inkjet head 1, which is a liquid ejection head according to the first embodiment, and an inkjet recording device 100, which is a liquid ejection device, will be described with reference to the drawings. FIG. 1 is a cross-sectional view showing a configuration of a part of the inkjet head 1 according to the first embodiment, and FIG. 2 is a cross-sectional view showing a configuration of a part of the inkjet head 1. FIG. 3 is a plan view showing a configuration of a part of a flow channel unit of the inkjet head 1. FIG. 4 is a graph related to flow channel shape and vibration characteristics. FIG. 5 depicts droplet ejection state under different conditions. FIG. 6 is a table showing ejection characteristics under different conditions. FIG. 7 depicts an inkjet recording device 100 or printer. The drawings are schematic and not necessarily to scale. Aspects may be omitted or exaggerated for purposes of explanation.

As shown in FIG. 1 and FIG. 2, the inkjet head 1 is provided with an actuator unit 20, a vibrating plate 30, and a manifold 40. The manifold 40 includes a plurality of flow channel substrates 401, 402, and 403. A nozzle plate 50 includes a plurality of nozzles 51. A frame unit 45 is provided as is a drive circuit 70. In the present embodiment, there is shown an example in which a stacking direction of piezoelectric body layers 211, a vibration direction of a piezoelectric element 21, and a vibration direction of the vibrating plate 30 are each parallel to the Z direction. In the present embodiment, a flow channel structure unit which forms an ink flow channel 35 (flow channel unit) inside the inkjet head 1 with the vibrating plate 30 and the manifold 40 is configured at a reverse side (backside) of the nozzle plate 50. The inkjet head 1 is of a circulation type in which the liquid is circulated along flow channels within the inkjet head 1.

The actuator unit 20 is provided with driving piezoelectric elements 21 (piezoelectric units or actuators) and non-driving piezoelectric elements 22. These elements can be formed of, for example, piezoelectric materials, and are alternately arranged along a column direction. In the present embodiment, the nozzles 51 are disposed at the midpoint of the actuator unit 20 along the Y direction, and the actuator unit 20 has a structure that is symmetric about the nozzles 51 on each side in the Y direction. For example, the actuator unit 20 is bonded to a base having a rectangular shape.

In the actuator unit 20, the plurality of driving piezoelectric elements 21 and the plurality of non-driving piezoelectric elements 22 are arranged at constant intervals therebetween. As an example, the driving piezoelectric elements 21 and the non-driving piezoelectric elements 22 all have rectangular solid columnar shapes in cross section. The actuator unit 20 may be formed by being divided into a plurality of parts by a plurality of grooves 23 such that the driving piezoelectric elements 21 and the non-driving piezoelectric elements 22 are arranged at the same pitch with the grooves 23 therebetween.

For example, the driving piezoelectric elements 21 and the non-driving piezoelectric elements 22 are each have a rectangular shape the short-side direction of which is parallel to the column direction and the longitudinal direction of which is parallel to an extending direction perpendicular to the column direction and the Z direction in a plan view viewed from the Z direction is an axial direction of the nozzle 51.

The driving piezoelectric elements 21 are arranged at positions respectively opposed to the one of the pressure chambers 31 of plurality of pressure chambers 31 in the Z direction. In this example, the center position along the column direction and the extending direction of the driving piezoelectric element 21 and the center position along the column direction and the extending direction of the pressure chamber 31 are arranged to match in the Z direction.

The non-driving piezoelectric elements 22 are arranged at positions respectively opposed to a partition wall part 42 of manifold 40 in the Z direction. In this example, the center position along the column direction and the extending direction of the non-driving piezoelectric element 22 and the center position in the column direction and the extending direction of the partition wall part 42 are arranged to match in the Z direction.

For example, the stack type piezoelectric member forming the actuator unit 20 is formed by stacking sheets of piezoelectric and then sintering the piezoelectric materials. For the actuator unit 20, grooves 23 are formed by performing a dicing-like processing on the piezoelectric member, and this serves to form the plurality of piezoelectric elements (21,22) in rectangular columnar shapes at predetermined intervals. Further, electrodes and other wiring as necessary are then provided for the plurality of columnar elements thus formed, and thus, the plurality of driving piezoelectric elements 21 and the plurality of non-driving piezoelectric elements 22 are formed. The adjacent driving piezoelectric elements 21 and the non-driving piezoelectric elements 22 face each other across the grooves 23.

The portion of the piezoelectric member constituting a driving piezoelectric 21 and element a non-driving piezoelectric element 22 are both portions of the stacked piezoelectric body. That is, the driving piezoelectric element 21 and the non-driving piezoelectric element 22 are both provided with a plurality of piezoelectric body layers 211 stacked on one another, and internal electrodes 221, 222 formed on principal surfaces of the piezoelectric body layers 211. It should be noted that, in this example, the driving piezoelectric element 21 and the non-driving piezoelectric element 22 have the same stacked structure. Furthermore, the driving piezoelectric element 21 and the non-driving piezoelectric element 22 are each provided with external electrodes 223, 224 formed on an outer surface thereof.

The piezoelectric body layer 211 is formed of the piezoelectric material such as a lead zirconate titanate (PZT) based piezoelectric material or a lead-free potassium sodium niobate (KNN) based piezoelectric material. The plurality of piezoelectric body layers 211 is stacked so that the thickness direction is parallel to the stacking direction. In the present embodiment, the thickness direction and the stacking direction of the piezoelectric body layers 211 are arranged along the vibration direction (the Z direction).

The internal electrodes 221, 222 are conductive films formed of a conductive material which can be sintered. For example, the conductive material may be silver-palladium. The internal electrodes 221, 222 are formed in a predetermined area on the principal surface of each of the piezoelectric body layers 211. The internal electrodes 221, 222 are used for a different polarity from each other. For example, the internal electrode 221 reaches one end of the piezoelectric body layer 211 but not the other end (opposite end) of the piezoelectric body layer 211 in (the Y direction). The internal electrode 222 is formed in so that it reaches the opposite end of the piezoelectric body layer 211 from the internal electrode 221, but fails to reach the other end of the piezoelectric body layer 211 at which the internal electrode 221 is present. The internal electrodes 221 are coupled to the external electrodes 224 formed on a side surface of the piezoelectric elements 21, 22. Internal electrodes 222 are coupled to the external electrodes 223 on a side surface of the piezoelectric elements 21, 22.

Further, the stacked type piezoelectric member for forming the driving piezoelectric elements 21 and the non-driving piezoelectric elements 22 may further be provided with a dummy layer at one or both of the end portions at the nozzle plate 50 side or the opposite side from the nozzle plate 50. For example, the dummy layer is formed of the same material as a piezoelectric body layer 211, but has an electrode at just one side (end) thereof, and is therefore not subjected to an electric field, and is therefore not deformed. For example, the dummy layer does not function as an active portion of the piezoelectric body, and serves to fix the actuator unit 20 to the base or provides a polishing margin available for when polishing is necessary for achieving dimensional accuracy or the like during assembly or after assembly.

The external electrodes 223, 224 are formed on the surfaces of the plurality of driving piezoelectric elements 21 and the plurality of non-driving piezoelectric elements 22, and are configured by collecting end portions of the internal electrodes 221, 222. For example, the external electrodes 223, 224 are respectively formed on opposite end surfaces of the piezoelectric body layers 211. The external electrodes 223, 224 may be deposited as Ni, Cr, Au layers or the like using a method such as a plating or sputtering. The external electrode 223 and the external electrode 224 are used for different polarities from each other. The external electrode 223 and the external electrode 224 can be disposed on different sides from each other, but, in some examples, the external electrodes 223, 224 may be laid out or have a portion drawn out from the same side surface of the plurality of driving piezoelectric elements 21 and the plurality of non-driving piezoelectric elements 22 as each other.

In an embodiment the external electrode 223 is set as an individual electrode, and the external electrode 224 is set as a common electrode. The external electrodes 223 (individual electrodes) are divided by the grooves 23 and are arranged independently (isolated) of each other. The external electrodes 224 forming the common electrode can be formed of continuous electrode layer on the side surface of the actuator unit 20. The external electrodes 224 (common electrodes) may be used as a grounded electrode, for example. The external electrodes 223, 224 are coupled to the drive circuit 70 via, for example, a wiring film. For example, each of the external electrodes 223, 224 is coupled to a control unit 150 via a driver IC 72 of the drive circuit 70, and is configured so as to be able to be subjected to drive control. It should be noted that the arrangement of the common electrode and the individual electrodes may be reversed in other examples.

The vibration direction of each of the piezoelectric elements 21, 22 is parallel to the stacking direction, and is displaced toward the d33 direction by application of an electric field. In each of the piezoelectric elements 21, 22, the number of piezoelectric body layers 211 and the internal electrodes 221, 222 is three or more. As an example, the number of layers in each of the piezoelectric elements 21, 22 is set no less than three but no greater than fifty. The thickness of each layer is set no less than 10 μm and no greater than 40 μm, and the thickness (total thickness) of the total number of layers is less than 100 μm.

In the inkjet head 1, the driving piezoelectric element 21 vibrates in response to the voltage being applied to the internal electrodes 221, 222 via the external electrodes 223, 224. In the present embodiment, the driving piezoelectric element 21 makes a longitudinal vibration along the stacking direction of the piezoelectric body layers 211. The longitudinal vibration mentioned here means, for example, a “vibration in the thickness direction defined by a piezoelectric constant d33”. The driving piezoelectric element 21 displaces the vibrating plate 30 with the longitudinal vibration to deform the pressure chamber 31.

The vibrating plate 30 extends along a plane perpendicular to the Z direction as the vibration direction, and is bonded to a surface at one side in the vibration direction, namely the nozzle plate 50 side, of the piezoelectric body layer 211 of the plurality of piezoelectric elements 21, 22. The vibrating plate 30 is opposed to the plurality of nozzles 51 via the pressure chambers 31 in the Z direction as the vibration direction. The vibrating plate 30 is configured so as to be able to deform. The vibrating plate 30 is bonded to the frame unit 45 and the driving piezoelectric elements 21 and the non-driving piezoelectric elements 22 of the actuator unit 20. For example, the vibrating plate 30 includes a vibration area 301 opposed to the piezoelectric elements 21, 22 and a support area 302 opposed to the frame unit 45. The vibrating plate 30 is disposed between the flow channel substrate 401 and the actuator unit 20. The vibrating plate 30 is disposed so as to overlap the plurality of flow channel substrates 401, 402, and 403, and forms a part of the ink flow channel 35.

The vibration area 301 has a generally plate shape. A surface direction of the vibrating plate 30 extends in the arrangement direction of the plurality of driving piezoelectric elements 21 and the plurality of non-driving piezoelectric elements 22. The vibrating plate 30 is, for example, a metal plate. The vibrating plate 30 includes a plurality of vibrating regions which are respectively opposed to one of the pressure chambers 31. These vibrating regions can be individually displaced. The vibrating plate 30 can be formed as a plurality of vibrating regions joined integrally with each other.

As an example, the vibrating plate 30 is formed of nickel or a stainless steel (SUS) plate with a thickness dimension along the vibration direction in a range from 5 μm to 15 μm. It should be noted that in the vibration area 301, a crease or a step may be formed in a region adjacent to the vibrating region or between the vibrating regions adjacent to each other so as to facilitate the displacement of the plurality of vibrating regions. A region of the vibration area 301 opposed to a driving piezoelectric element 21 is displaced due to expansion and contraction of the driving piezoelectric element 21, and thus, the vibration area 301 locally deforms. In some examples, the vibrating plate 30 may have an extremely thin and complicated shape, and thus may be formed by an electroforming method or the like. The vibrating plate 30 is joined to an upper end surface of the actuator unit 20 by physical bonding or the like.

The support area 302 is a plate-like member disposed between the frame unit 45 and the flow channel substrate 401. The vibrating plate 30 has a structure symmetric about the nozzles 51 in the Y direction. The support area 302 of the vibrating plate 30 can be disposed between a common liquid chamber 32 and a second common liquid chamber 33. For example, the support area 302 can be provided with open parts 303 connecting the second common liquid chamber 33 and the common liquid chamber 32 with each other.

The manifold 40 is bonded on one side of the vibrating plate 30.

As shown in FIG. 1 through FIG. 3, the manifold 40 is provided as a plurality of flow channel substrates 401, 402, and 403 stacked on one another. For example, in accordance with viscosity of the ink, a volume of the ink to be ejected, and so on, the plurality of flow channel substrates 401, 402, and 403 having open parts or grooves, the nozzle plate 50, and the vibrating plate 30 are bonded to each other in combination with each other to form the desired ink flow channel 35. The plurality of flow channel substrates 401, 402, and 403 are disposed so as to be stacked on one another, and the predetermined ink flow channel 35 comprising the second common liquid chamber 33, a coupling flow channel 34 (an aperture flow channel), and pressure chambers 31 is formed with the openings or the grooves provided by each of the flow channel substrates 401, 402, and 403. As an example, the flow channel substrates 401, 402, and 403 are disposed so as to be stacked on one another from the vibrating plate 30 side, and the flow channel substrate 403 is disposed so as to be opposed to the nozzle plate 50.

The manifold 40 can be disposed between the nozzle plate 50 and the vibrating plate 30. Inside the manifold 40, there is the predetermined ink flow channel 35 (a liquid chamber) including the plurality of pressure chambers 31, the second common liquid chambers 33 connected with the first common liquid chambers 32, and a plurality of coupling flow channels 34 which reach the pressure chambers 31 from the second common liquid chambers 33. For example, an area corresponding to three columns of pressure chambers is shown in FIG. 3.

As shown in FIG. 1 and FIG. 2, the flow channel substrate 401 is bonded to the vibrating plate 30. The flow channel substrate 401 is a plate-like member having the same outer shape as that of the vibrating plate 30, and is formed of a metal material, such as SUS430 (a stainless steel alloy), or a resin material, such as silicone. The flow channel substrate 401 includes first open parts 4011, each forming a part of the pressure chamber 31, and second open parts 4012, each constituting a part of the second common liquid chamber 33. For example, the first open part 4011 is disposed at a middle portion of the ink flow channel 35 and the second open parts 4012 are disposed at the ends.

The flow channel substrate 402 is bonded to the flow channel substrate 401. The flow channel substrate 402 is a plate-like member having the same shape as that of the flow channel substrate 401, and is formed of a metal material, such as SUS430, or a resin material, such as silicone. The flow channel substrate 402 includes first open parts 4021 each forming a part of the pressure chamber 31, second open parts 4022 each constituting a part of the second common liquid chamber 33, and slit opening parts 4023 constituting the coupling flow channels 34 as individual flow channels. For example, the first open parts 4021 are disposed at the middle portion of the ink flow channel 35, the slit opening parts 4023 are disposed at both ends of the first open parts 4021, and the second open parts 4022 are respectively disposed in end portions at outer side of the slit opening parts 4023. The open parts 4021, 4022, and 4023 are each arranged in a plurality of columns.

As shown in FIG. 1 through FIG. 3, the flow channel substrate 403 is stacked on and bonded to the flow channel substrate 402. The flow channel substrate 403 is a plate-like member having the same shape as that of the vibrating plate 30, and is formed of a metal material, such as SUS430, or a resin material, such as silicone. The flow channel substrate 403 includes first open parts 4031 each forming a part of the pressure chamber 31 and second open parts 4032 each constituting a part of the second common liquid chamber 33. For example, the first open part 4031 is disposed at a middle portion of the ink flow channel 35, and the second open parts 4032 are disposed at both ends.

In an example, flow channel substrates 401, 402, and 403 are formed to have a thickness of between 20 μm and 100 μm. For a 300 dpi printing head, the pitch of the arrangement of the pressure chambers 31 is 169 μm, the width WA of the pressure chambers 31 is in a range of 100 μm to 150 μm, and the width WB of the slit opening part 4023 (forming the coupling flow channel 34) is less than the width of the first open part 4021 and the width of the second open part 4022. It should be noted that the widths WA, WB are each a dimension (a width) in the X direction. In other words, the coupling flow channel 34 has a flow channel resistance enhancement part 341 with a cross-sectional area less than the pressure chamber 31. As an example, in the present embodiment, the coupling flow channel 34 has the flow channel cross-sectional area that is uniform for the entire length, and thus the whole length of the coupling flow channel 34 forms the flow channel resistance enhancement part 341.

In the manifold 40, the plurality of pressure chambers 31 is formed by the first open parts 4011, 4021, and 4031 of the flow channel substrates 401, 402, and 403 which are arranged in the stacking direction, and which connect to each other. The plurality of pressure chambers 31 is spaces formed at one side of the vibration area 301 of the vibrating plate 30, and each of the pressure chambers 31 is respectively connected to a nozzle 51 provided in the nozzle plate 50. Further, the pressure chamber 31 is covered by the vibrating plate 30 at an opposite side to the nozzle plate 50.

The pressure chambers 31 are connected to the first common liquid chambers 32 via the open parts 303 passing through the coupling flow channels 34 and the second common liquid chambers 33. The pressure chamber 31 retains the liquid supplied from the first common liquid chambers 32 through the second common liquid chambers 33 and the coupling flow channels 34, and then ejects the liquid from the nozzle! response to the deformation (vibration) of the vibrating plate 30 corresponding to the pressure chamber 31. The pressure chamber 31 is formed so that its cross-sectional area perpendicular to the Y direction (the flow direction) is less than or equal to 0.01 mm².

In the manifold 40, the second common liquid chambers 33 are constituted by the second open parts 4012, 4022, and 4032 which are arranged in the stacking direction, and which connect to each other.

The second common liquid chambers 33 are flow channels connected to the end portions (in the flow direction) of coupling flow channels 34. The second common liquid chambers 33 are formed between the vibrating plate 30 and the nozzle plate 50, and are connected to the first common liquid chambers 32 of the frame unit 45. Here, each of the flow channel substrates 401, 402, and 403 has the structure in which each side in the Y direction are symmetric about the nozzles 51. The second common liquid chambers 33 are disposed at both sides (in the Y direction) of the pressure chambers 31 and are equal to each other in the flow channel length and have the same flow channel cross-sectional shape as each other.

In the manifold 40, the coupling flow channels 34 are formed by the slit opening parts 4023 of the flow channel substrate 402. The coupling flow channels 34 connect the respective pressure chambers 31 to one of the second common liquid chambers 33, and extend in the Y direction (flow direction). The coupling flow channels 34 are configured to have a smaller dimension in the width direction as compared to the second common liquid chambers 33 and the pressure chambers 31. The individual coupling flow channels 34 have a smaller flow channel cross-sectional area than the pressure chamber 31 to which it is connected. Likewise, the individual coupling flow channels 34 have a smaller flow channel cross-section area than the second common liquid chamber to which it is connected.

Here, each of the flow channel substrates 401, 402, and 403 are symmetric centering on the nozzles 51, and the coupling flow channels 34 disposed on opposite sides are configured to be equal to each other in flow channel length and flow channel cross-sectional shape. In the manifold 40, the partition wall parts 42 for partitioning the plurality of pressure chambers 31 are formed in regions on the periphery of the first open parts 4011, 4021, and 4031.

The partition wall parts 42 are wall-like members which separate the plurality of pressure chambers 31 from each other in the arrangement direction. The partition wall parts 42 are disposed so as to be opposed to a non-driving piezoelectric element 22 via the vibrating plate 30. The portion wall part 42 is supported by the non-driving piezoelectric element 22. The partition wall parts 42 are disposed at the same pitch as the plurality of pressure chambers 31.

In the manifold 40, the side wall parts 43 which partition coupling flow channels 34 are formed by regions on both sides of the slit opening parts 4023 of the flow channel substrate 402.

The side wall parts 43 are wall-like members which separate the plurality of coupling flow channels 34 from each other in the arrangement direction. For example, the side wall parts 43 are disposed so as to be connected to both sides of the pressure chamber 31. The side wall part 43 is configured so that the coupling flow channel 34 becomes higher in flow channel resistance than the inside of the pressure chamber 31 by the coupling flow channel 34 becoming smaller in flow channel cross-sectional area than the pressure chamber 31. The plurality of side wall parts 43 is disposed at the same pitch as the plurality of pressure chambers 31.

Here, the coupling flow channel 34, as a fluid resistance enhancement part, is configured so as to be smaller in cross-sectional area than the pressure chamber 31 to which it is connected. For the coupling flow channel 34, (cross-sectional area of the pressure chamber 31)/(cross-sectional area of the coupling flow channel 34) is, for example, greater than or equal to 4. In other words, the cross-sectional area of the pressure chamber 31 is four or more times as large as the cross-sectional area of the coupling flow channel 34.

In other words, the coupling flow channel 34 is smaller (narrower) than the pressure chamber 31 in at least one of its width dimension or height dimension.

In the present example, the width WA of the coupling flow channel is set as width WA=70 μm, and the width WB of the pressure chamber 31 is set as width WB=130 μm. Further, the height HA (dimension in the Z direction) of the coupling flow channel 34 is set as height HA=25 μm, and the height HB of the pressure chamber 31 is set as height HB=75 μm. Therefore, (cross-sectional area of the pressure chamber 31)/(cross-sectional area of the coupling flow channel 34) is greater than or equal to 4.

It should be noted that, in this example, the length dimensions in the extending direction (the Y direction) are length LA of the coupling flow channel 34 is length LA=0.9 mm and the length LB of the pressure chamber 31 is length LB=1.35 mm.

The nozzle plate 50 is formed as a rectangular plate made of metal, such as SUS·Ni, or a resin material, such as polyimide. The nozzle plate 50 has a thickness of about 10 μm to 100 μm. The nozzle plate 50 is disposed on one side of the manifold 40 so as to cover the opening (open end) of the pressure chamber 31. The nozzle plate 50 includes the plurality of nozzles 51 for ejecting droplets. The plurality of nozzles 51 are holes which penetrate the nozzle plate 50 in the thickness direction. The plurality of nozzles 51 is arranged in the same direction as the pressure chambers 31 to form a nozzle array. The nozzles 51 are respectively disposed at positions corresponding to one of the plurality of pressure chambers 31.

The frame unit 45 is a structure component to be bonded to the vibrating plate 30 together with the piezoelectric elements 21, 22. The frame unit 45 is disposed at an opposite side to the manifold 40 of the vibrating plate 30. The frame unit 45 forms a outer contour of the inkjet head 1. In some examples, the frame unit 45 may be used for forming flow channels, holding the liquid inside framed area, or the like. In the present embodiment, the frame unit 45 is bonded to the vibrating plate 30, and the first common liquid chambers 32 are formed in a region between the frame unit 45 and the vibrating plate 30.

The first common liquid chambers 32 are within the framed area of the frame unit 45, and are connected to the pressure chambers 31 through the open parts 303 provided in the vibrating plate 30, the second common liquid chambers 33, and the coupling flow channels 34.

The drive circuit 70 is provided with a wiring film or the like. One end of wiring film is coupled to the external electrodes 223, 224. A driver IC is mounted on the wiring film. A printed wiring board is mounted on the other end of the wiring film.

The drive circuit 70 applies the drive voltages to the external electrodes 223, 224 with the driver IC. Application of the drive voltages drives the piezoelectric elements 21, and thus, increases or decreases the volumes of the pressure chambers 31 to eject droplets from the nozzles 51.

The wiring film is coupled to the external electrodes 223, 224. For example, the wiring film is an anisotropically-conductive film (ACF) fixed to coupling portions of the external electrodes 223, 224 with thermocompression bonding. The wiring film is, for example, a chip on film (COF) on which the driver IC is mounted.

The driver IC is coupled to the external electrodes 223, 224 via the wiring film. It should be noted that the driver IC may be coupled to the external electrodes 223, 224 with other measures such as an anisotropically-conductive paste (ACP), a nonconductive film (NCF), or a nonconductive paste (NCP) instead.

The driver IC generates control signals and drive signals for making the piezoelectric elements 21 operate in accordance with print data or the like. The driver IC generates the control signals for control such as selecting the timing of ejecting the ink and selecting the piezoelectric element 21 which ejects the ink in accordance with an image signal from the control unit 150 of the inkjet recording device 100. Further, the driver IC generates the voltages to be applied to the piezoelectric elements 21, namely the drive signals (electric signals), in accordance with the control signals. When the driver IC applies the drive signal to a piezoelectric element 21, the piezoelectric element 21 reacts so to displace the vibrating plate 30 to change the volume of the pressure chamber 31. Thus, a pressure vibration occurs in the ink in the pressure chamber 31. Due to the pressure vibration, the ink is ejected from the nozzle 51. It is possible for the inkjet head 1 to be able to realize gradation expression (grayscale printing) by changing the volume of an ink droplet or droplets to be landed for one pixel. Further, it is possible for the inkjet head 1 to be able to change the amount of the ink landed in one pixel by changing the number of times of ejection of the ink (number of droplets per pixel). As described above, the driver IC is an example of an application unit for applying the drive signals to the piezoelectric elements 21.

For example, the driver IC is provided with a data buffer, a decoder, and drivers. The data buffer saves the print data for each of the piezoelectric elements 21 in a time-series manner. The decoder controls the driver based on the print data saved in the data buffer for each of the piezoelectric elements 21. The drivers output the drive signals for making the respective piezoelectric elements 21 operate based on the control of the decoder. The drive signals are, for example, voltages to be applied to the respective piezoelectric elements 21.

The printed wiring board can be a printing wiring assembly (PWA) on which a variety of electronic components and connectors can be mounted. The printed wiring board is coupled to (connected to) the control unit 150 of the inkjet recording device 100.

In the inkjet head 1, an ink flow channel 35 including a plurality of pressure chambers 31 connect to nozzles 51, individual flow channels are formed by the coupling flow channels 34 respectively connected to the plurality of pressure chambers 31. Coupling flow channels 34 are respectively disposed on the both sides of the pressure chambers 31, and common chambers formed by the common liquid chambers 33, 32 are at both sides.

In this example, inkjet head 1 is of the circulation type, and the first common liquid chamber 32 is connected to a cartridge, and the ink is supplied to the pressure chambers 31 through the first common liquid chamber 32 at the inflow side. All the piezoelectric elements 21 are coupled to wiring lines so that the voltages can be individually applied to the piezoelectric elements 21. In the inkjet head 1, when the control unit 150 applies the drive voltage to certain electrodes 221, 222 with the driver IC, the corresponding (targeted) piezoelectric element 21 vibrates in the stacking direction of the piezoelectric body layers 211. In other words, the piezoelectric element 21 makes a longitudinal vibration.

Specifically, the control unit 150 applies the drive voltage to the internal electrodes 221, 222 of the targeted piezoelectric element 21 to selectively drive this piezoelectric element 21. Then, the deformation in a tensile direction and the deformation in a compression direction due to the driven piezoelectric element 21 are combined with each other to deform the vibrating plate 30 to change the volume of the pressure chamber 31 to thereby intake liquid from the first common liquid chamber 32, and then eject the liquid from the nozzle 51.

The ink supplied to the pressure chamber 31 can be ejected from the nozzle 51 or, if not ejected, collected in the cartridge via the coupling flow channel 34, the second common liquid chamber 33, and the first common liquid chamber at the other side (collection side).

In the inkjet head 1, the ink flows in the ink flow channel 35 from the inflow side (supply side) to outflow side (the collection side).

An example of the inkjet recording device 100 equipped with an inkjet head 1 will be described with reference to FIG. 7. The inkjet recording device 100 is provided with a chassis 111, a medium supply unit 112, an image forming unit 113, a medium discharge unit 114, a conveyance device 115, and the control unit 150.

The inkjet recording device 100 is a liquid ejection device which ejects a liquid such as ink while conveying a print medium, such as sheet P, as an ejection target along a conveyance path A from the medium supply unit 112 to the medium discharge unit 114 passing through the image forming unit 113 to thereby perform image formation (printing) on the sheet P.

The chassis 111 forms the outer contour shape of the inkjet recording device 100. A discharge opening for discharging the sheet P is disposed at a position on the chassis 111.

The medium supply unit 112 is provided with a plurality of paper cassettes and is configured to be able to hold a plurality of sheets P of a variety of sizes.

The medium discharge unit 114 is provided with a catch tray configured to be able to hold a sheet P discharged from the discharge opening.

The image forming unit 113 is provided with a support unit 117 for supporting the sheet P, and a plurality of head units 130 disposed above the support unit 117 so as to be opposed to the support unit 117.

The support unit 117 is provided with a conveyance belt 118 having a loop shape, a support plate 118 for supporting the conveyance belt 119, and a plurality of belt rollers 118 provided at the reverse side of the conveyance belt 120.

When forming an image, the support unit 117 supports the sheet P on an upper surface of the conveyance belt 118 and feeds the conveyance belt 118 at a predetermined timing by rotation of the belt rollers 120 to thereby convey the sheet P downstream.

The head units 130 are respectively provided for a plurality (e.g., four colors) of inkjet heads 1, ink tanks 132 are respectively mounted on the inkjet heads 1, coupling channels 133 are provided for respectively coupling the inkjet heads 1 and the ink tanks 132 to each other along with supply pumps 134.

In the present embodiment, inkjet heads 1 for four colors, namely cyan, magenta, yellow, and black, and the ink tanks 132 for these colors are provided. The ink tanks 132 are coupled to the inkjet heads 1 with the coupling channels 133, respectively.

The ink tanks 132 can be connected to negative pressure control devices, such as pumps. By performing pressure control of the inside of the ink tanks 132 with the negative pressure control device in accordance with hydraulic head values of the inkjet head 1 and the ink tank 132, a meniscus having a predetermined shape can be provided to the ink in each of the nozzles 51 of the inkjet head 1.

The supply pumps 134 are each a liquid feeding pump formed of, for example, a piezoelectric pump. The supply pumps 134 can be disposed in the supply flow channels. The supply pumps 134 are coupled to the drive circuit of the control unit 150 with the wiring lines and are controlled by a central processing unit (CPU) or the like. The supply pumps 134 each supply an inkjet head 1 with liquid.

The conveyance device 115 conveys the sheet P along the conveyance path A from the medium supply unit 112 to the medium discharge unit 114 through the image forming unit 113. The conveyance device 115 is provided with a plurality of guide plate pairs 121 and a plurality of conveying rollers 122 arranged along the conveyance path A.

The guide plate pairs 121 are a pair of plate members arranged so as to be opposed to each other across the sheet P path and serve as guides for the sheet P on the conveyance path A.

The conveying rollers 122 are driven by the control unit 150 to feed the sheet P downstream along the conveyance path A. It should be noted that sensors for detecting conveyance state of the sheet may be arranged at a variety of places along the conveyance path A.

The control unit 150 has a control circuit 151, such as a CPU, and functions as a controller. The control unit 150 also has a read only memory (ROM) for storing a variety of programs, a random access memory (RAM) for temporarily storing a variety of variable data, image data, and so on, and an interface unit for input of data from the outside and output of data to the outside.

In the inkjet recording device 100, when the control unit 150 detects a print instruction from the operation input unit, the control unit 150 drives the conveyance device 115 to convey the sheet P, and then outputs print signals to the head units 130 at predetermined timing to drive the inkjet heads 1. For an ejection operation, the driver IC transmits a drive signal (driving signal) based on an image signal established according to the image data. The drive signal causes the drive voltage to be applied to the internal electrodes 221, 221 permitting the piezoelectric elements 21 to be selectively targeted and driven. The piezoelectric elements 21 when driven generate a longitudinal vibration in the stacking direction and this changes the volume of a pressure chamber 31 to thereby eject ink from a nozzle 51 to form an image on the sheet P on the conveyance belt 118. Furthermore, as part of the liquid ejection operation, the control unit 150 drives the supply pumps 134 to supply ink from the ink tanks 132 to the first common liquid chambers 32 of the inkjet heads 1 as necessary.

Here, a drive operation of driving the inkjet head 1 will be described. The inkjet head 1 according to the present embodiment is provided with the piezoelectric elements 21 disposed so as to be opposed to the pressure chambers 31, and these piezoelectric elements 21 are coupled so that the voltage can be applied thereto with the wiring lines. The control unit 150 transmits the drive signal to the driver IC based on the image signal established according to the image data to apply a drive voltage to the internal electrodes 221, 222 of the piezoelectric elements 21 to selectively deform the piezoelectric elements 21. Then, by combining the deformation in the tensile direction (expansion) and the deformation in the compression direction (contraction) of the vibrating plate 30 with each other to change the volume of the pressure chamber 31, the liquid is ejected.

For example, the control unit 150 alternately performs tension actions and compression actions. In the inkjet head 1, when increasing (expanding) the volume of a pressure chamber 31, the piezoelectric element 21 is contracted while those piezoelectric elements 21 which are not a driving target are not deformed. Further, in the inkjet head 1, when decreasing (contracting) the volume of the pressure chamber 31, the driving piezoelectric element 21 is expanded, while the non-driven piezoelectric elements 21 are not deformed.

With the inkjet head 1 and the inkjet recording device 100 as described above, the influence of the parasitic vibration is suppressed, and it is possible to ensure a good ejection performance.

In other words, in an embodiment, the coupling flow channels 34 and the common liquid chambers 32, 33 are disposed on both sides of the pressure chambers 31 to provide the configuration for circulating the ink. By setting the cross-sectional area (taken perpendicular to the ink flow) of the pressure chamber 31 to be less than or equal to 0.01 mm² and the value of (cross-sectional area of the pressure chamber 31)/(cross-sectional area of the coupling flow channel 34) to be greater than or equal to 4, it becomes possible to perform printing without being affected by the parasitic vibration while still permitting the keeping of the beneficial effects of circulation.

FIG. 4 is a graph showing the vibration characteristics for different cross-sectional area ratios. FIG. 4 shows the results obtained by performing FFT analysis on ink ejection results with the cross-sectional area ratio between the pressure chamber and the coupling flow channel set to be equal to or higher than 4 (solid line) and lower than 4 (dotted line). In FIG. 4, the horizontal axis represents frequency (kHz), and the vertical axis represents amplitude. As shown in FIG. 4, the influence on the circulation performance and the influence of the parasitic vibration differ when the cross-sectional area perpendicular to the ink flow of the pressure chamber 31 and the cross-sectional area of the coupling flow channel 34 differ. In this context, parasitic vibration refers to the vibration with peaks P2, P3 beyond the main vibration P1.

FIG. 5 depicts a droplet flying state for the ejected ink when parasitic vibration is present and not. It can be seen that when the parasitic vibration is present, the size of a first droplet D1 is smaller and the size of a second droplet D2 is larger than when not present. Furthermore, FIG. 5 shows that when the parasitic vibration is not present, the size of the first droplet D1 and the size of the second droplet D2 are kept more equivalent to each other. In other words, when the parasitic vibration is strong (as evaluated by peak ratio to the main vibration), the first droplet becomes smaller, as shown in FIG. 5, and this may deteriorate the print quality. The higher the cross-sectional area ratio (pressure chamber 31)/(coupling flow channel 34) is, the weaker the parasitic vibration becomes, and thus the smaller the parasitic vibration peak becomes.

FIG. 6 shows test results for ejecting ink while for different cross-sectional areas of the pressure chamber 31 and the coupling flow channel 34. For these different dimension combinations, circulation was evaluated as flow rates produced at the same pressure. In FIG. 6, “circulation effect,” “high-speed follow-up performance,” and “ejection failure due to the parasitic vibration,” results were evaluated and are as presented. Here, the “circulation effect” evaluates whether it is possible to perform a normal ink ejection after the head has been left idle (no printing/ejection) for some amount of time. If proper ejection is possible from the beginning (e.g., without a nozzle/head clearing process or the like) after leaving the sample head idle for a certain period of time (e.g., several hours), it is determined that the “circulation effect” is obtained (result entry=“GOOD”). When the sample fails to perform ejection right from the beginning after the idle period, it is determined that the circulation effect was not obtained, and accordingly, the evaluation result is listed as POOR. For the “high-speed follow-up performance,” an upper limit of a frequency band in which the variation in ejection speed becomes stable (within a certain range or margin) is shown.

As can be understood from FIG. 6, the larger the pressure chamber 31 is, the lower the circulation flow rate becomes, and the more difficult it becomes to obtain a good circulation effect. It can also be seen that the high-speed follow-up performance is determined by the cross-sectional area of the coupling flow channel 34. It can also be seen that parasitic vibration has no significant effect when setting (cross-sectional area of the pressure chamber 31)/(cross-sectional area of the coupling flow channel 34) to be equal to or higher than 4. Therefore, according to the present embodiment, by setting the cross-sectional area perpendicular to the ink flow of the pressure chamber 31 to be less than or equal to 0.01 μm², and setting (cross-sectional area of the pressure chamber 31)/(cross-sectional area of the coupling flow channel 34) greater than or equal to 4, it becomes possible to perform good printing without parasitic vibration effects while still maintaining a good circulation effect.

It should be noted that the present disclosure is not limited to example dimensions and arrangements of FIG. 6.

In one example, the cross-sectional area is uniform throughout the entire length of the coupling flow channel, and a flow channel resistance enhancement part is formed over the entire length of the coupling flow channel, but this is not a limitation. It is possible to adopt a configuration in which the flow channel resistance enhancement part (portion where the cross-sectional area is smaller than other areas) is disposed in just a middle part of the coupling flow channel. Further, the cross-sectional area within the flow channel resistance enhancement part is not required to be uniform. In such a case, it may be sufficient to adopt a configuration in which the minimum cross-sectional area in the coupling flow channel 34 is less than a quarter of the cross-sectional area of the pressure chamber 31.

The specific configuration of the manifold 40 is not limited to the above examples. In an embodiment, the manifold is formed with the three flow channel substrates 401, 402, and 403, but in other examples the number of the flow channel substrates can be two, or four or more. Furthermore, the shapes of the open parts in each of the flow channel substrates 401, 402 are not limited to those in the embodiment described above.

In an embodiment, the second open parts 4012, 4022, and 4032 are divided in the arrangement direction into the columns of the pressure chambers 31 to form the second common liquid chambers 33, but this is not a limitation, and it is possible for the plurality of second open parts 4012, 4022, and 4032 to continue in the arrangement direction to form the common flow channels.

In an embodiment, multiple layers of piezoelectric material are stacked one on another, and the piezoelectric elements 21 are driven for a longitudinal vibration (d33) in the stacking direction, but this is not a limitation. An embodiment may have piezoelectric elements 21 that are each formed of a single layer piezoelectric material, and an embodiment may also perform the driving with a transversal vibration (d31).

Further, the specific configurations of the piezoelectric elements 21, 22, the shapes of the flow channels, the configurations of and the positional relationship between the variety of components including the manifold 40, the nozzle plate 50, and the frame unit 45 are not limited to the example described above, but may be changed as appropriate. Further, the arrangements of the nozzles 51 and the pressure chambers 31 are not limited to the above. For example, the nozzles 51 may be arranged in two or more columns. Furthermore, in some examples, dummy chambers may be formed between pressure chambers 31.

The liquid to be ejected is not limited to ink for printing, and it is possible to eject a liquid including conductive particles for forming wiring patterns on a printed wiring board.

In an embodiment, inkjet head 1 is used in an liquid ejection device such as the inkjet recording device or printer, but this is not a limitation. The inkjet head 1 may be used in, for example, a 3D printer, an industrial manufacturing machine, and medical devices, and aspects of the described embodiments permit reductions in the size, the weight, and the cost in such other applications.

According to at least one of the embodiments described, it is possible to more easily set or design the desired flow channel shapes.

In addition, although some embodiments of the present disclosure are described, these embodiments are illustrative only, but it is not intended to limit the scope of the present disclosure. These novel embodiments can be implemented with other various aspects, and a variety of omissions, replacements, and modifications can be made within the scope or the spirit of the present disclosure. These embodiments and the modifications thereof are included in the scope of the disclosure, and at the same time, included in the disclosure set forth in the appended claims and the equivalents thereof.

What is claimed is:

1. A liquid ejection head, comprising:
a plurality of pressure chambers, each pressure chamber connected to a nozzle;
a first-side common liquid chamber on a first side of the plurality of pressure chambers;
a second-side common liquid chamber on a second side of the plurality of pressure chambers, the plurality of pressure chambers being between the first-side common liquid chamber and the second-side common liquid chamber in a first direction;
a plurality of first coupling flow channels, each first coupling flow channel being respectively connected to a first side of one of the pressure chambers and the first-side common liquid chamber; and
a plurality of second coupling flow channels, each second coupling flow channel being respectively connected to a second side of one of the pressure chambers and the second-side common liquid chamber, wherein
a cross-sectional area of each pressure chamber in the plurality of pressure chambers taken perpendicular to the first direction is less than or equal to 0.01 mm², and
a cross-sectional area of each of the first and second coupling flow channels taken perpendicular to the first direction is less than one quarter of the cross-sectional area of each pressure chamber in the plurality of pressure chambers.

2. The liquid ejection head according to claim 1, wherein the first coupling flow channels have the same length along the first direction as the second coupling flow channels.

3. The liquid ejection head according to claim 1, wherein the cross-sectional area of each first coupling flow channel is the same as the cross-sectional area of each second coupling flow channel.

4. The liquid ejection head according to claim 1, wherein each first coupling flow channel has the same cross-sectional area for its full length in the first direction.

5. The liquid ejection head according to claim 4, wherein each second coupling flow channel has the same cross-sectional area for its full length in the first direction.

6. The liquid ejection head according to claim 1, wherein the cross-sectional area of each of the first and second coupling flow channel is the minimum cross-sectional area along the full length of the respective first and second coupling flow channel in the first direction.

7. The liquid ejection head according to claim 1, further comprising:
a nozzle plate including a plurality of nozzles at positions corresponding to the plurality of pressure chambers;
a vibration member including a plurality of vibrating regions at positions corresponding to the plurality of pressure chambers, the plurality of pressure chambers being between the nozzle plate and the vibration member; and
an actuator unit including a plurality of piezoelectric elements at positions corresponding to the plurality of vibrating regions, the vibration member being between the actuator unit and the plurality of pressure chambers.

8. A liquid ejection device, comprising:
an ink jet head; and
a controller configured to cause the ink jet head to eject liquid, wherein
the ink jet head includes:
a plurality of pressure chambers, each pressure chamber connected to a nozzle,
a first-side common liquid chamber on a first side of the plurality of pressure chambers,
a second-side common liquid chamber on a second side of the plurality of pressure chambers, the plurality of pressure chambers being between the first-side common liquid chamber and the second-side common liquid chamber in a first direction,
a plurality of first coupling flow channels, each first coupling flow channel being respectively connected to a first side of one of the pressure chambers and the first-side common liquid chamber, and
a plurality of second coupling flow channels, each second coupling flow channel being respectively connected to a second side of one of the pressure chambers and the second-side common liquid chamber;
a cross-sectional area of each pressure chamber in the plurality of pressure chambers taken perpendicular to the first direction is less than or equal to 0.01 mm²; and
a cross-sectional area of each of the first and second coupling flow channels taken perpendicular to the first direction is less than one quarter of the cross-sectional area of each pressure chamber in the plurality of pressure chambers.

9. The liquid ejection device according to claim 8, wherein each first coupling flow channel has the same cross-sectional area for its full length in the first direction.

10. The liquid ejection device according to claim 9, wherein each second coupling flow channel has the same cross-sectional area for its full length in the first direction.

11. The liquid ejection device according to claim 8, wherein the cross-sectional area of each of the first and second coupling flow channel is the minimum cross-sectional area along the full length of the respective first and second coupling flow channel in the first direction.

12. The liquid ejection device according to claim 8, wherein the ink jet head further includes:
a nozzle plate including a plurality of nozzles at positions corresponding to the plurality of pressure chambers;
a vibration member including a plurality of vibrating regions at positions corresponding to the plurality of pressure chambers, the plurality of pressure chambers being between the nozzle plate and the vibration member; and
an actuator unit including a plurality of piezoelectric elements at positions corresponding to the plurality of vibrating regions, the vibration member being between the actuator unit and the plurality of pressure chambers.

13. A liquid ejection head, comprising:
a plurality of pressure chambers;
a nozzle plate including a plurality of nozzles at positions corresponding to the plurality of pressure chambers, each pressure chamber being respectively connected to a nozzle in the plurality of nozzles;
a vibration member including a plurality of vibrating regions at positions corresponding to the plurality of pressure chambers, the plurality of pressure chambers being between the nozzle plate and the vibration member;
an actuator unit including a plurality of piezoelectric elements at positions corresponding to the plurality of vibrating regions, the vibration member being between the actuator unit and the plurality of pressure chambers;
a first-side common liquid chamber on a first side of the plurality of pressure chambers;
a second-side common liquid chamber on a second side of the plurality of pressure chambers, the plurality of pressure chambers being between the first-side common liquid chamber and the second-side common liquid chamber in a first direction;
a plurality of first coupling flow channels, each first coupling flow channel being respectively connected to a first side of one of the pressure chambers and the first-side common liquid chamber; and
a plurality of second coupling flow channels, each second coupling flow channel being respectively connected to a second side of one of the pressure chambers and the second-side common liquid chamber, wherein
a cross-sectional area of each pressure chamber in the plurality of pressure chambers taken perpendicular to the first direction is less than or equal to 0.01 mm², and
a cross-sectional area of each of the first and second coupling flow channels taken perpendicular to the first direction is less than one quarter of the cross-sectional area of each pressure chamber in the plurality of pressure chambers.

14. The liquid ejection head according to claim 13, wherein the first coupling flow channels have the same length along the first direction as the second coupling flow channels.

15. The liquid ejection head according to claim 13, wherein the cross-sectional area of each first coupling flow channel is the same as the cross-sectional area of each second coupling flow channel.

16. The liquid ejection head according to claim 13, wherein each first coupling flow channel has the same cross-sectional area for its full length in the first direction.

17. The liquid ejection head according to claim 16, wherein each second coupling flow channel has the same cross-sectional area for its full length in the first direction.

18. The liquid ejection head according to claim 13, wherein the cross-sectional area of each of the first and second coupling flow channel is the minimum cross-sectional area along the full length of the respective first and second coupling flow channel in the first direction.

19. A liquid ejection device, comprising:
a controller; and
a liquid ejection head according to claim 18, wherein
the controller is configured to cause the liquid ejection head to eject liquid.

20. A liquid ejection device, comprising:
a controller; and
a liquid ejection head according to claim 13, wherein
the controller is configured to cause the liquid ejection head to eject liquid.
